(19) United States
(12) Patent Application Publication
(10) Pub. No.: US 2005/0179246 A1
(43) Pub. Date: Aug. 18, 2005

(54) Kit for use by persons having brain function deficit

(76) Inventors: Lisa Keller, Santa Fe, NM (US); Sandra J. Knutson, Dallas, TX (US)

Correspondence Address: PEACOCK MYERS AND ADAMS P C, P O BOX 26927, ALBUQUERQUE, NM, 871256927, US

(21) Appl. No.: 10/995,852

(22) Filed: Nov. 22, 2004

Related U.S. Application Data
(60) Provisional application No. 60/524,322, filed on Nov. 21, 2003.

(51) Int. Cl. B42D 1/00

(52) U.S. Cl. 281/15.1

(57) ABSTRACT

A kit, and method of using the kit, for use by persons having brain function deficit, and by persons helping the affected person, to plan, organize, and manage the tasks of daily life to promote the independence of the affected person's lifestyle. A daily planner book is used in combination with a color-coded system of adhesive stickers, writing instruments, and note papers to classify the affected person's activities into one ore more designated categories of life tasks. By assigning life tasks to discrete categories and implementing a system of color-coded reminders, the affected person with the assistance of a friend organizes, plans, and executes his daily activities in an orderly manner, with emphasis on accepting the person's affected condition, supporting the affected person, and fostering conduct (such as adequate rest) to optimize potential recovery. Mnemonic components are supplied with the kit to assist the affected person in remembering tasks of high importance needing immediate attention. Educational books, workbooks, and videotapes of digital video disks provide instruction and support to the users of the kit.

### CROSS-REFERENCE TO RELATED APPLICATIONS

This application claims the benefit of the filing of U.S. Provisional Patent Application Ser. No. 60/524,322, entitled “Brain Injury Recovery Kit,” filed on Nov. 21, 2004, and the specification thereof is incorporated herein by reference

### BACKGROUND OF THE INVENTION

1. Field of the Invention (Technical Field)

The present invention relates to a kit apparatus or system for assisting persons with brain function deficits to organize and recall the ordinary tasks and routines of daily life.

2. Background Art

There are numerous human conditions or afflictions that cause a person to suffer from brain deficits. Various diseases, including but not limited to Alzheimer's Disease, may compromise a patient's ability to recall memorized information and data, process information, and organize tasks or plan personal activity. Certain neurological disorders, such as attention deficit disorder (ADD), or attention deficit hyperactivity disorder (ADHD) similarly can impair the patient's mental faculties. Also, traumatic injury can compromise brain function, resulting in increased challenges in the recovering person's daily life, even in instances where recovery is adequate to permit the person to resume a mostly independent lifestyle.

A brain injury is a blow to the head strong enough to injure the brain. Most brain injuries are caused by: automobile accidents, sports injuries, falling and violence. The correct term for these injuries, no matter how mild or severe, is a traumatic brain injury (TBI). Strokes and brain tumors are not considered traumatically induced brain injuries—but their surgical intervention can cause injury to the brain—and in any event a stroke or tumor can impact brain function. Traumatic brain injury can occur in an instant, and it happens every day across the United States of America. Almost 6,000 people sustain a traumatic brain injury in the USA every day, and at least 5.3 million Americans are currently living with deficits from a TBI.

A traumatic brain injury is one of the most devastating and life-altering events that can happen to a person. A brain injury can change a person's life as well as the lives of their families. This is due in part to a changed personality as the person may experience deficits or losses in areas of pre-injury competency and skills. Living with a brain injury can be very difficult as the individual attempts to return to some semblance of normalcy.

Every brain function deficit is different, and varies from person to person. However, there are commonalities of deficits and these are the areas addressed by the present invention, such as the ability to pay attention, to facilitate the remembering of newly learned information, people, places and things, the ability to organize one's day or activities, techniques for relearning, decision making, problem solving and support for dealing with behavioral and emotional changes.

A need exists for a method, system, or kit to assist persons afflicted with brain function deficits, as well as family members and friends of such persons, to deal with the life-changing challenges mentioned above. The present invention provides such assistance, and addresses the social connections in the patient's life, for example their employer, employees, banks, medical providers, and local retailers. It is contemplated that the invention will find primary use in the assistance of people who are experiencing TBI; however, it will be readily apparent that the invention may also have utility in assisting persons affected by disease or neurological disorder which compromises brain function, such as Alzheimer's' disease and similar maladies.

### SUMMARY OF THE INVENTION

The present invention comprises a complete system for the person who must deal with brain function deficits. The person with brain function deficits is referred to herein as the “experiencing person” or “EP.” The invention also has utility on the hands of family and friends of the experiencing person. It provides easy to understand information about brain injury through videos/DVDs and books. It includes hands-on tools for the practical application of the techniques presented in the invention. A kit is provided with various components which permit the recovering patient, and an assistant or “buddy,” to organize and execute the tasks of daily living, thereby increasing the person's self-confidence and personal organization and independence.

The apparatus according to the present invention includes a number of separate components, all of which can be integrated into a single kit for organized use in assisting a person experiencing a brain function deficit to optimize his or her quality of life. Most of the components belong to at least one of three general groups: instructional video tapes or digital video disks, the elements of a “buddy system,” and practical tools for daily use.

The series of video tapes or DVD disks describe in detail the methods necessary to handle the day-to-day challenges after traumatic brain injury. The series explains TBI, how deficits may present themselves, and ideas on how they can be dealt with. The videos clearly show the use of the tools contained in the kit, which educate and address the various support systems that will be needed for the duration of the patient's life. Topics include: cognitive and behavioral issues, the importance of medication and compliance, vocational rehabilitation concerns and finding national and regional resources.

“The buddy system” includes two books, one for the buddy and a workbook for the person with a brain injury. The books compliment the videos with step-by-step instructions on the most effective use of the tools, and the need for the methods of providing support to the person living with a brain injury. How to be a Buddy is taught in the book and DVD. A buddy is not the doctor, nor the therapist. And a Buddy is more than a regular friend. It is a special role to be a Buddy for a person with a brain injury.

The tools include a “memory machine”, a daybook scheduler that is coordinated with the memory machine and a number of other tools and resources that are used to deal with the deficits that come with brain injury. The memory machine is an electronic digital voice recorder with record and play-back functions. The memory machine is programmed specially to allow the user(s) to record messages to the experiencing person, and have the messages played back to the experiencing person at pre-scheduled times. The messages can be reminders about particular tasks or goals needing attention at the particular time.

The tools of the kit also include a unique color coding system which consists of collections of colored items to assist the experiencing person in organizing and sequencing tasks. Particular colors are associated with certain categories of tasks, which can be categorized by type, or location, and/or time. For example, a busy mother with a TBI may select the color orange, which indicates “high priority” for the category of appointments related to her children's school and important activities. A simple blue sticker (blue indicating usual family matters) would be used for more general, loss urgent or important, activities and appoints for children and/or spouse. Color stickers can be placed on certain household items associated with that category of tasks. Further, the day-timer type schedule book can have color-coded dividers and/or pages, or color stickers inserted, to remind the user about goals tasks, and deadlines pertaining to the children and their after-school activities. Keys, papers, packages, and other items can be prominently tagged with strings or stickers of the appropriate color to enable the experiencing person to remember and sequence tasks, having concurrent reference to the Memory Machine and the daily scheduler.

The invention offers a positive approach to a devastating change. Its objects include, but are not limited to: (1) The provision of hands-on tools to address deficits; (2) To supply a method of support for the person with a deficit and his or her family; (3) To assist the person with dysfunction or deficit to return to the most productive and meaningful life possible; and (4) To provide up-to-date education on traumatic brain injury (coping and prevention).

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a perspective view of the collected compoenents of a kit apparatus according to the present invention; and

FIG. 2 is an enlarged perspective view of the color coding system portion of the kit seen in FIG. 1, including seven packets in folders, each packet including items of a different color, including colored marking instruments, groups of colored adhesive stickers, and groups of colored self-adhesive note papers.

### DESCRIPTION OF THE PREFERRED EMBODIMENTS (BEST MODES FOR CARRYING OUT THE INVENTION)

A brain injury or a brain or neurological disorder or disease may leave the sufferer with neurological deficits. After a brain deficit occurs, daily activities the person previously performed, even sometimes out of habit or routine, may become very challenging. The person may require substantial assistance. The person may have deficits with memory, decision making, perception, or thought processing. The person with brain function deficits is referred to herein as the “experiencing person” or “EP.”

An experiencing person may try, for example, to leave the house to go somewhere. To avoid forgetting the object of leaving, the sufferer has written on a piece of paper the directions to where he is going, only to reach the car and realize he forgot his wallet. Paper in hand, he returns inside to get his wallet. While inside retrieving the wallet, he puts down his keys. He goes back to the car, and realizes he locked his keys in the house. After figuring out a way to get back inside, he finds his keys, gets distracted, and lays the piece of paper with the directions down on the table—and goes back outside to the car. He now has his wallet and keys, so he drives off. But without the piece of paper he can't remember where he's going. Then the discouraging cycle could start all over again. The present invention assists in dealing with deficits which result in memory, attention and activity sequencing challenges such as these.

The invention is a system or kit integrating very accessible education about brain function deficits. The kit may include information about deficits resulting from TBI, its effects and what needs to be done, to assist the person with the disability with the day-to-day routines of life. The kit also includes hands-on tools, and provides methods that assist in the process of the patient's “getting her life back”, with information and resources for the patient and the family. Besides assisting the affected individual, the inventive kit helps the individual's family learn to cope with this devastating change, and it ensures that the patient will have an optimized quality of life.

The invention helps the user living with a brain deficit manage his daily life and obtain appropriate care of the related problems. An important result of using the invention is more appropriate expectations of the person with the deficit, thereby reducing the tremendous stress and frustration he or she experiences daily.

Also, a brain deficit may result in a high risk of sustaining a second head injury resulting in additional deficits. It is known that after one TBI, the risk for a second injury is three times greater, and after a second TBI, the risk of a third injury is eight times greater—and with each injury less function is likely to return. Perception, attention, sleep disturbance, and other deficits all contribute to this possibility. The inventive kit helps reduce the possibility of a second injury.

The inventive kit encourages the experiencing person to engage in ordinary activities outside the home and thus avoid social isolation. Other users learn to seek support for the patient and his/her friends. The kit also assists a non-patient co-user to learn improved ways to communicate with the experiencing person: the amount of stimulation, the warning signs of exhaustion, the tone, the response, the reminders to rest and the reassurances that improvements are being made.

The kit according to the present invention includes the collection of integrated components, using color-coded tools, that assist the experiencing person and his mentor (called a “buddy” herein), to re-establish the experiencing person into as normal a life as feasible. The components of the kit apparatus according to the invention are not extraordinary or atypical, and many or all are available commercially off-the-shelf. When combined and used according to the invention, however, the components of the kit provide a comprehensive system and method that transcends the components considered individually in its ability to foster a more independent, self-satisfying lifestyle for a person experiencing a functional brain deficit.

Throughout this specification, reference is made to “life tasks.” Life tasks include any of the individual activities commonly encountered or performed during the ordinary day of a typical person. Life tasks include but are not limited to planned appointments, goals, and deadlines for action. Life tasks comprehend individual personal matters, including but not limited to personal hygiene, medical care, hobbies and avocations, physical activities and sports, and the like. The life tasks may relate to family or social functions, including shopping, religious services and activity, the school and after-school activities of children, dates with spouse (or dating generally for single persons), and household management such as cooking, cleaning, and laundry. Life tasks also include activities pertaining to employment, career, or job search.

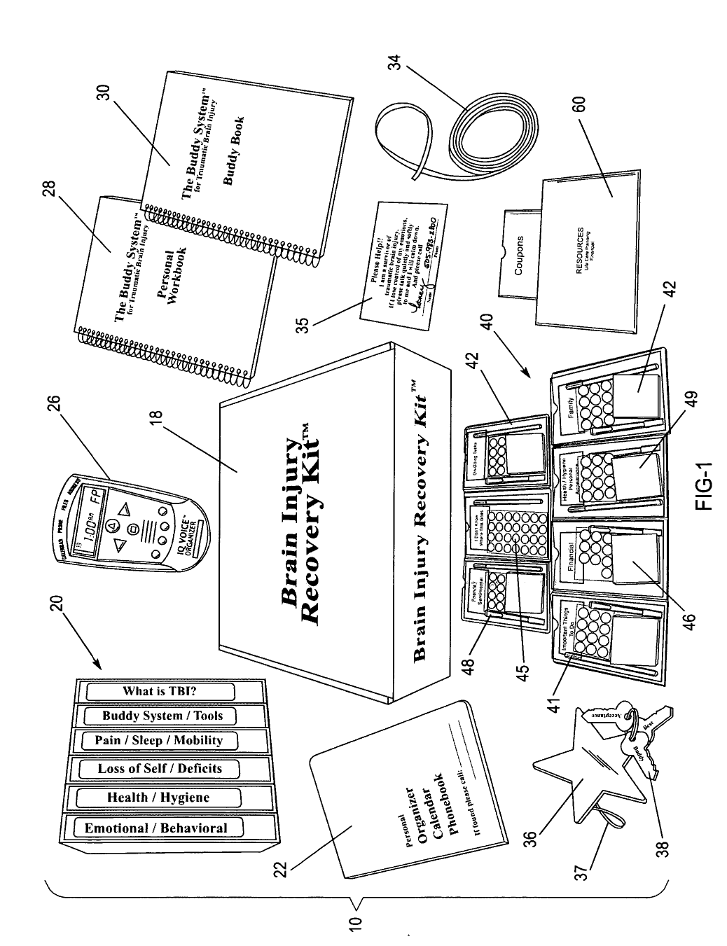

Reference is invited to FIG. 1. In the preferred embodiment, the entire contents of the inventive kit 10 can be collected and neatly arranged in a storage case 18 easily carried by a single person. The case 18 also preferably arranges the items of the kit 10 in an organized manner for orderly identification and access. Also very preferably, a package 18 containing the kit 10 is visually “quiet” when opened by the users for the first time. For example, each component may be individually wrapped in white paper, with a simple label identifying the contained item. The labels on the separately wrapped items optionally but preferably inform the user which item to open first, which to open second, and the like, so that initial use is properly ordered. In some embodiments, perhaps the sole kit component exposed to plain view when the package or storage case 18 is initially opened may be an introductory videotape or DVD providing an overview of the use the kit. Also, a simple instruction card may be proffered describing how to “step into” the kit 10.

The contents of the kit 10 according to the present invention are summarized as follows:

There is provided a series (for example six) of videotapes, or more preferably digital video disks (DVDs) 20, which offer audio-visual instruction on the following subjects: Who the kit is for and how to begin using it; teaching about brain function deficits (for example, discussion by experts in the field, which may be customized in a given kit to a specific deficit); the various degrees and types of deficit, and the varying degrees of possible recovery; the impossibility of knowing eventual outcome, without inducing false hopes; informative statistics; and available national resources. The DVD series 20 may also present information regarding “outlining the keys to recovery” (e.g. the paramount importance of scheduled or planned periods of physical rest, acceptance and support from family and community, and assistance from a Buddy); addressing the perceived “loss of self”; the “new” life begins; “getting through the day”; identifying what the experiencing person was able to do before, what ability has been lost or damaged, and what realistically can be done about it; teaching the change of approach to life which requires (in time) acceptance that the change in brain function has occurred and that the experiencing person will never be exactly the same as before; and educating the experiencing person and family that their willingness to work with the reality of what has occurred is necessary to any recovery that will be enjoyed.

The audio-visual tapes or DVDs 20 also preferably provide tutorials about the use of all the tools in the kit 10 (appointment book 22, memory machine 26, Buddy Book 28, EP Workbook 30, helper cord 34, “panic” card 35, rubber band with star 36, key chain 38, color coding system 40, and the kit 10 itself as a rehabilitation tool. These elements of the kit 10 are described further hereinafter. Teaching in steps, the DVD components 20 of the kit 10 show how to use the tools in relation to each other (e.g., first the daily appointment book 22 alone, the memory machine 26 alone, the color coding system 40 alone, and then and only then progressing to the use of combinations of kit components, such as the daily appointment book 22 in association with the memory machine 26, the appointment book in association with the color coding system 40, and the like.

The DVD series 20 preferably also provides instruction regarding behavioral changes in the experiencing person and their possible remedies; for example anger, sadness, depression, anxiety, fear/panic, personal sexuality, personal morality, and substance use/abuse Likewise, information is offered regarding cognitive deficits and possible solutions/approaches for handling them; categories include executive functions such as sequencing events, short term memory, long term memory, organizational abilities, time, location, awareness, self perception, perception of others, auditory deficits, visual deficits, and attention deficits resulting from TBI.

Later DVDs in the series 20 preferably cover social difficulties and possible solutions/approaches for handling them, safety issues and possible solutions/approaches for prevention of second injury, and ultimately financial difficulties and possible solutions/approaches for planning/handling changes.

In all instructional materials, double meanings should be avoided. Dual instructions also should be avoided. The overall kit 10 and its instructions must be kept simple, “quiet,” and uncluttered, with a non-intimidating presentation and facile use. Basic concepts and principle must not be diluted with distracting information. Ease of use is paramount, especially for the benefit of the typical experiencing person.

A second component of the kit 10 is the “buddy system” featuring a Buddy Book 30 and an EP Personal Workbook 28. The buddy book 30 is intended to stand alone or, preferably, to be used in conjunction with the DVDs 20. The buddy book 30 addresses all subjects that are on the DVDs 20, but the primary focus of the buddy book is to teach the “buddy” person how to be the most effective buddy to the experiencing person. The buddy book 30 provides guidance and support to the buddy and assists with an understanding of the task and speaks to the need for commitment to that task. The buddy book 30 can also be used by the EP when the EP is far enough along in their recovery to begin to guide themselves and use the kit 10 with less of the buddy's day-to-day involvement.

The buddy book 30 describes TBI (or other deficit-causing affliction) and how to be a buddy, and how to use all the contents of the kit 10. The buddy book 30 may be used by the buddy, or to help the experiencing person identify a buddy. The buddy book 30 offers a compassionate and realistic approach for the best possible outcome for the experiencing person, and guides the buddy to an understanding of the task, and the need for commitment to the task, of assisting the experiencing person. The buddy book offers guidance on what role a buddy should, and should not, play in the experiencing person's life. It offers advice about helping the experiencing person to use the Personal Workbook 28 component of the kit 10. The prospective or current buddy must also be educated to be able to relinquish or let go of his mentor role if and when his assistance is no longer needed—sometimes after years of deep involvement in the management of his charge's affairs. The buddy book 30 contains information redundant to that presented in all the DVDs 20. The buddy book 30 may contain information about how to transition to a subsequent buddy, if necessary, and/or how to successfully share responsibility with other buddies. The buddy book 30 may also be useful to the experiencing person when the experiencing person has progressed sufficiently in her recovery to begin to guide himself/herself, and to use the kit 10 with greatly reduced support from the buddy.

There also is provided, as a complementary companion to the buddy book 30, a personal workbook, the Experiencing Person's Workbook 28 for use by the experiencing person. The workbook 28 helps the experiencing person and the buddy identify the changes and put in place the needed supports, select the appropriate tools, and chart progress. By performing tasks presented in the workbook 28, the experiencing person is better able to identify changes in life, and to begin to develop day to day solutions to the specific problems faced as she struggles to get through the day. The workbook 28 will also help the experiencing person be more prepared to speak about her specific problems when she consults with her medical providers.

The personal workbook 28 contains self-directed assignments to help the affected person to ascertain what has and is happening to him, helps him identify what his personal deficits are (sequencing, memory, and the like). The workbook 28 also contains activities by which the experiencing person can determine and record progress in learning and recovery. The workbook 28 assists the affected person in identifying lifestyle changes, and how to put in place the necessary supports, to select the appropriate tools, and to chart progress, as he or she works with his or her buddy and the kit 10. For example, the experiencing person must learn and appreciate the importance of rest; at times when the patient senses elevated confusion, frustration, or anxiety from her deficit, she should take a ten minute rest break to promote healing.

Also included in the kit apparatus 10 for use in the method and system is a hand-held digital “voice organizer” 26 or memory machine, which is programmed to record and recognize the experiencing person's voice, to allow them to make recordings of self-reminders of important appointments, goals, tasks, and the like. A suitable digital voice organizer 26 will have a visual, audio, or vibratory alarm function, so that appointments or reminders are automatically signaled to the user at the appropriate time. A voice-activated memory machine 26 well-suited for use in the invention is offered under the trademark IQ VOICE, available from Voice Power Technologies, LLC., of Burlington, N.J. For example, a rechargeable battery-powered Voice Power Technologies IQ VOICE Model 5500, which includes a voice organizer with appointment calendar and memo pad, reminder, and phone directory, may be included as an integral element 26 of the kit 10. The voice organizer 26 preferably is accompanied by an appropriate carrying case.

A central component of the kit apparatus 10 is a planner book 22, preferably a loose-leaf, opening ring-binder-type appointment and calendar book with removable pages. Alternatively, a wire-bound appointment book may be used, particularly if provided with perforated pages for easy removal as needed. A suitable size planner book 22 would be a “desk” size, of about 5±2 inches by 8 1/2 inches (140 mm by 216 mm). The planner book 22 pages are printed with daily, and preferably weekly and monthly, appointments and notes sections, generally in accordance with known appointment books, except that the calendar and appointment notes layouts may be modified to the special needs of persons suffering the symptoms of a brain function deficit. Very preferably, the planner book 22 has a two-page-per-day format, wherein when the book is laid open, the left and right facing pages are presented to the user for managing the time and appointments of a single day (e.g., the left-hand page is demarked with hourly increments, and the right-side page across from the time sheet is available to write notes for the day). Preferably also, the upper outside corner of each page of the daily planner book 22 is perforated at an angle, to permit the corner to be “dog-eared” and torn off. The personal organizer book 22 may also include pages for collecting frequently-used telephone numbers, and pockets for business cards and credit cards and the like. In one very preferred embodiment, the planner book 22 may have a plurality of colored pouches into which papers and documents may be inserted for temporary sorting and storage. The colors of the pouches pertain to different categories of life tasks, as explained further herein below.

An appointment book 22 suitable for use in the invention, or which may by adapted for use, are commercially available from Day-Timers, Inc., of East Texas, Pa. 18046, including but not limited to the Day-Timers® “Lifestyle Planner Pages” and Day-Timers® “Planner Page Accessories” products, and for example the page filler set, Day-Timers, Inc., product number 92880, with perforated upper corners.

Continued reference is made to FIG. 1. The planner book 22 is used in association with a color coding system 40 having an assortment, for example six or seven, of color-coding packets 41, 42, 44, 45, 46, 48, and 49. The packets define discrete groups of items, including groups of adhesive stickers, self-adhesive paper notes, and colored marking pens. Accordingly, each of packets 41, 42, 44, 45, 46, 48, and 49 includes a number of substantially uniformly colored items, that is, for example, there is a first packet 41 of orange-colored items, a second packet 42 of yellow-colored items, a third packet 44 of blue-colored items, a fourth packet 45 of red-colored items, a fifth packet 46 of green-colored items, a sixth packet 48 of pink items, and a seventh packet 49 of purple-colored items.

The colors of the kit 10 and color-coding system 40 are used consistently throughout the kit. An object of the invention is to teach a system and method where specific colors mean specific things. Therefore, color should not be used as pure aesthetic design as it can be in other projects. All the colors used in the color coding system 40 should be the same color when used on any other components of the kit 10. Any colors used preferably match as closely as possible throughout the kit.

Accordingly, all the colors need to be reserved for the exact meaning assigned to them in the color coding system. (For example, green always relates with money issues, blue with family/buddy, yellow relates with ongoing projects, etc.) If colors are used in any way on other components of the kit 10 besides the color coding system 40, the following are recommended: For the buddy book 30, the related color is Blue; for the planner book 22, the related color is orange; for the EP workbook 28, the associated color is yellow; for the memory machine 26, the related color is orange. In this manner, the consistency important for learning after TBI is maintained. Repetition and routine are important in order to grasp concepts. The colors of the kit 10 color coding system are reserved to help simplify the complexities of daily living, and color coding is a critical help to the users of the kit 10.

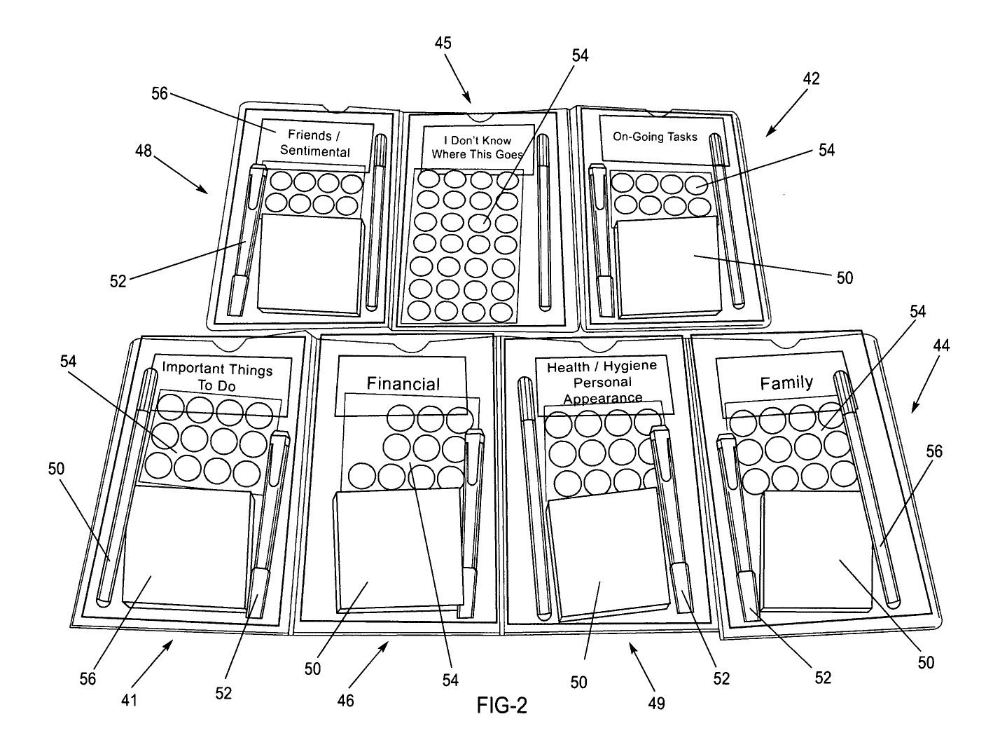

FIG. 2 shows the color-coding system 40 according to the present invention. The color-coding system 40 features a collection of packets as seen in FIG. 1. The packets are all identical to one another, except as to color, so description of the contents of any packet (e.g. 41 or 44) serves to describe each of the other packets—again, except that each packet contains items of a different color. Referring to FIG. 2, each one of the color-coding packets 41, 42, 44, 45, 46, 48, and 49 preferably includes the following items, all of which are preferably uniformly colored in the corresponding color: (1) at least one pad of small removably “sticky” self-adhesive note papers 50 (e.g., the well-known the Post-It® brand notes, such as product number 653AU available from 3M Company of Minneapolis, Minn.), (2) a marking instrument 52 with ink or colored lead of the corresponding color, and (3) a plurality of adhesive stickers 54, preferably round in shape and about one-half inch to about one inch in diameter; and (4) a lightweight cardboard folder 56 with a particular use category (described further herein) clearly printed thereon. These contents in turn preferably are disposed inside clear plastic pouches for storage of the items of the particular color. The pouches and the cardboard folder 56 are clearly labeled by life task category, such as “Friends/Sentimental”, “I Don't Know Where This Goes,” “Ongoing Tasks,” “Important Things to Do,” “Financial,” Health/Hygiene/Personal Appearance,” and “Family.”

The colors of the packet items correspond to designated categories of life tasks. So, the users of the kit 10 rapidly learn to associate a selected color with a particular type of activity, relationship, or assignment. The system and practice of organizing the experiencing person's life tasks and routines by category, and then assigning a separate color to each category, promotes organization in daily living and fosters the self-confidence of the experiencing person, allowing them a measure of peace of mind as they assume some control of their life despite their brain function deficit.

By way of example, the system and method of categorizing life tasks, and assigning a separate color to each category, are suggested to be established as follows. Orange items correspond to tasks having highest priority, those which are critical and must receive urgent attention. Green items correspond to life tasks associated with money and finances. Blue items correspond to life tasks pertaining to family, “buddy,” and home. Yellow items correspond to ongoing daily necessities such as health, hygiene, or personal appearance and uncompleted projects, (particularly, for example, job, employment, or career-related tasks). Red is the color assigned to items or tasks that the experiencing person needs help categorizing, that is, it corresponds to an “I don't know where this goes” category. Pink items correspond to friends, sentimental tasks, and anniversaries. Purple items may be provided in the kit, and are left without an assigned or labeled category, allowing the users to identify and implement a categorization customized to an individually selected need. Thus, one preferred embodiment of the kit 10, having an “unassigned” color packet of items, permits flexibility and adaptation to the needs of the user as they are identified.

The consistent use of colors to classify and organize is a significant facet of the apparatus and method of the invention. Insofar as practically possible in manufacturing, the colors need to be consistently used to associate related items, and to correlate them to the corresponding life-task category. It is important, to facilitate use by the affected person, that the same bright orange, the same crisp blue is always used, with no subdued oranges, dull blues, stripes, or variations etc. Colors when used need to match, preferably exactly, throughout the kit. Preferably, for example, there are matching orange, green, blue, yellow, pink, red and purple pouch-like pages in the daily planner book, so that the experiencing person can place small objects and documents into pouches corresponding to the life task to which the objects or documents pertain.

The kit 10 apparatus according to the invention preferably includes a panic card 35. The panic card 35 provides useful information to other persons who may encounter the experiencing person in times of confusion, emotional upset, or socially disruptive behavior. The panic card 35, which may be orange-colored or trimmed in orange to correspond to the life task category of urgent tasks, has text useful to others (such as strangers on the street, police) to assist the experiencing person out of a difficult circumstance by informing the other person about the patent's TBI, her specific difficulty, how to communicate with the experiencing person, and how to get in touch (e.g. by telephone) with the experiencing person's designated “buddy” for information and assistance.

The kit 10 preferably includes a durable, flexible cord 34, which may be made from a non-elastically bendable plastic. The cord 34 is colored bright orange (consistently with the other orange items for the orange life tasks category). The cord 34 preferably is about 12 to 24 inches long. The cord 34 is used in the method of the invention for inviting attention to items needing the prompt attention or immediate focus of the experiencing person. For example the TBI patent may loosely tie the orange cord 34 to a microwave oven handle, to remind her that she placed food in the microwave, and turned it on, prior to leaving the kitchen for a few moments. Upon re-entering the kitchen, the experiencing person is reminded, by the bright orange “flag,” that the microwave oven should be the object of immediate attention. The orange cord 34 similarly can be temporarily tied, wrapped, or laid upon virtually any item as a flag for the user's attention. It also may be used to teach mental focusing skills to persons affected with ADD

Another preferable but optional component of the kit is a durable elastic band 37, such as a common “rubber band,” with a brightly colored five-pointed star 36 (e.g., about two or three inches across) attached thereon. The rubber band 37 is disposed around the experiencing person's wrist, where it and the star 36 serve as a constant reminder to him or her to use the tools and teachings of the kit 10 while proceeding from task-to task during the day.

A key chain is provided, preferably bright orange in color, with three simulated keys 38 thereon. The keys 38 preferably are formed from a durable rigid plastic, and each key has a different one of the three following words plainly printed, molded, or embossed thereon: REST ACCEPTANCE, or BUDDY. These keys 38 are the reminder keys to recovery, that the experiencing person keeps handy (for example in a purse or pocket) to return his or her attention to these three basic concepts several times each day.

The kit 10 apparatus preferably but optionally includes a simple, laminated cardboard instruction card with seven succinct points of initial instructive text, notifying the users how to begin using the kit for the first time.

For the user's convenience and for marketing purposes, the kit 10 may include an assortment of promotional coupons 60, from various sources, for products and supplies for decreasing pain, enhancing relaxation, personal safety, etc., such as therapeutic pillows, helmets, accessories for the digit voice organizer, and the like.

The method of the invention is best practiced by two users, the person experiencing the deficit and a person who can serve as an assistant and supporter. Both the experiencing person and his “buddy” make use of the kit apparatus 10. The buddy preferably is a person in a peer relationship with the experiencing person, such as a friend or sibling, rather than a supervisor such as a parent or clergy.

The kit 10 can be introduced to the family of an experiencing person as soon as the deficit is apparent, and it is realized that the experiencing person will require assistance in future daily tasks. Even before the patient has returned home from the medical facility, the family or friends can begin searching for an individual who will serve as the buddy. Of course, at the outset of the practice of the invention, a member of the family may serve as a buddy according to the invention, and some other, non-family buddy may emerge over time later on. When the kit 10 is used the first time, the user(s) view the introductory DVD to obtain an overview of the system, the kit components, and the system's processes and goals. The buddy should then obtain and read carefully the buddy book 30 to learn to be a buddy according to the invention. The buddy then may proceed to review and learn the materials on the others in the series of DVD presentations 20. Persons with a deficit who have been recovering or in rehabilitation for a lengthy period of time may profitably begin reviewing the DVD materials 20 as well. Subsequent to the introductory video, the DVD series 20 need not be viewed in any particular order, and the users may proceed directly to any particular DVD containing subject matter of specific interest to the circumstances presented.

After understanding the contents of the DVD, the users begin using the daily planner book 22.

In the preferred method, the experiencing person uses the color coding system 40 incrementally, by first beginning to designate only urgent life tasks with the orange items (notes 50, stickers 54, and writing instrument 52 from the orange packet 41. Indeed, at the outset of practicing the invention, the experiencing person may employ the kit 10 as an aid in learning (with assistance from the buddy) to distinguish between critical and non-critical tasks. The users must learn to use the orange “important tasks” items sparingly, for tasks and subjects of utmost importance only. After beginning to master the use of one color to categorize and manage this first type of life task, the user(s) may begin using a second color along with the first orange color, for example by introducing the yellow items into the practice of the invention in order to track, manage, and plan ongoing projects and items associated therewith. With sufficient experience using two colors, a third, and then a fourth, may be added to the experiencing person's repertoire. As the experienced person gains experience, confidence, and proficiency in the use of the kit 10, with the aid and encouragement of his buddy, he eventually may make routine use of all the color packets 41, 42, 44, 45, 46, 48, and 49 of items to organize and manage most or all the life tasks with which he routinely is confronted. Because the brain deficit may not, perhaps likely will not, ever be fully healed and eliminated, the kit 10 becomes a life-long aide to the experiencing person's independent or semi-independent living.

The orange cord 34 is used to flag items of immediate concern or interest to the experiencing person. As mentioned, the cord 34 is a plastic string or cord, colored bright orange according to the kit's color schemes. It is thin, lightweight, and durable yet flexible, to be easily coiled and carried on the person. The cord 34 is wrapped around, or tied to, any object requiring the patent's current interest (but which otherwise may be forgotten) such as a book, an electrical appliance, a camera, toothbrush, cellular telephone, or any other item. For example, if the experiencing person is viewing one of the DVDs 20 from the inventive kit 10 for the first time, but is interrupted,—for example by the need for a physical rest—she can remove the DVD from the machine, place it in its cover, and wrap the orange cord 34 around the cover as a reminder to resume viewing the DVD. When the experiencing person returns to the room, the orange cord 34 alerts him to the fact that the DVD is the next item requiring her attention. Thus, the orange cord is a universal “priority” reminder flag.

The thin, credit-card sized panic card 35 preferably is of durable plastic or laminated paper, and is trimmed in orange color. The experiencing person or his buddy writes on the panic card 35 the buddy's contact information (telephone numbers, addresses) needed for the experiencing person to contact the buddy in times of urgent need, but when the experiencing person is unable to remember such information. The experiencing person carries the panic card 35 with him always or nearly always, so that assistance and support is available any time it is needed.

The experiencing person carries with him from the kit the reminder keychain 38, which is a flexible loop upon which are threaded three facsimile keys, e.g., plastic key-shaped trinkets. The keys are differently colored, and are prominently and permanently labeled “buddy,” “rest,” and “acceptance,” respectively. These fake keys 38 are the “keys to recovery” to which the experiencing person periodically is to refer, and preferably are carried about by the experiencing person during the day. The large keychain signals that “things have changed,” while the accompanying star image remind the users of the importance of hope.

Described generally, the method of the invention thus is for organizing and planning the life tasks of a person with a functional brain deficit, the method including the steps of selecting a plurality of life tasks needing organization; assigning a different color to each of the life tasks, each color thereby corresponding to a task; assembling a collection of colored adhesive stickers wherein the collection has at least two groups of stickers, each group comprising a plurality of stickers of a selected color corresponding to one of the plurality of designated categories of life tasks; writing a particular life task annotation on the page of a planner book; selecting an adhesive sticker of a color corresponding to the particular life task; and affixing at least one colored sticker to the page adjacent to the annotation. An understanding of these steps is had with reference to the description above of the kit apparatus, and the method is further described herein below.

The basic method also features the further steps of assembling a collection of colored self-adhesive note papers wherein the collection has at least two groups of note papers, each group comprising a plurality of note papers of a selected color corresponding to one of the plurality of designated categories of life tasks; selecting a note paper of a color corresponding to a particular life task; and temporarily attaching the note paper to an object associated with the life task. Additioanl steps include assembling a collection of at least two colored writing instruments wherein each instrument marks in a selected color corresponding to one of the plurality of designated categories of life tasks; selecting an instrument of a color corresponding to a particular life task; and marking with the selected instrument the page adjacent to the annotation. The step of marking with the selected instrument can also extend to marking an object, nearly any common object besides the planner book, associated with the life task. The method preferably is performed by the person with a functional brain deficit with the assistance of a second person.

The method aso includes the important step of viewing at least one of a series of audiovisual presentations of information regarding functional brain deficits, which viewing preferably is performed by the person with a functional brain deficit and by a person selected to assist the person. In the method, the experiencing person and/or the person assisting the experiencing person makes and audio recording a reminder message regarding the particular life task in a digital voice organizer apparatus; and later replays the reminder message to the person with a functional brain deficit.

According to the method of the invention, the experiencing person, with assistance from her buddy, uses the planner book 22 in combination with color coding system 40, especially the colored stickers 54 to undertake a regimen of planning each day's tasks and activities. Appointments and tasks are recorded in advance (for example, daily by the experiencing person and twice weekly with the buddy) for the upcoming week or month, and/or daily with the buddy alone, in the appropriate sections of the book 22. As suggested by the buddy or desired by the experiencing person, the colored self-adhesive stickers 54 from the packets 41, 42, 44, 45, 46, 48, and 49 are affixed at appropriate locations in the pages of the planner book 22 (e.g., adjacent to appointment times) to assist the user in identifying the type of task to be accomplished; the easily understood identification occurs by assigning to appointments or goals one (or more) of the major life task categories. By way of example, the need to visit the bank on a particular day can be indicated and reinforced in the planner book 22 by placing a green sticker 54 (indicating finances) at the top of the page pertaining to the date of interest. Similarly, a specific time appointment with a hairdresser or barber can be indicated with a yellow sticker dot 54 (health, hygiene, personal appearance) at the corresponding location in the timekeeping section of page of the date book 22 for the appropriate date. If the experiencing person has any concern that the appointment might be overlooked, an additional (e.g. orange) sticker 54 can be placed beside the appointment, or an orange mark can be made beside the yellow sticker. The use of handwritten notes in combination with the colored adhesive stickers 54 provides dual reinforcement to the user's mind.

By the inventive method, as tasks in the planner book 22 are fulfilled or addressed, they may be crossed out, and a day's activities evaluated at the end of each day. Notes and reminders pertaining to missed or unaccomplished tasks can be “moved” or re-recorded on the next day's appointment pages, so as not to be overlooked and forgotten. When the information for a given day is processed, either by being stricken or re-annotated to a later date, the perforated corner of the corresponding page of the planner book 22 is torn away, indicating to the user that the information for that date has been completely processed. The experiencing person, often with the assistance of her buddy, periodically (for example weekly) reviews the planner book 22 and its contents, to organize and process any documents that have been placed therein, to record past events, and prepare for future ones.

Also according to the invention, a writing instrument, such as a colored pen, pencil, or marker 52 is used in a like manner to highlight items according to category. An experiencing person confronted with volumes of reading material, including material written by the person himself, can “highlight” passages of printed text or handwritten notes, or selected portions of receipts or invoices, and the like, with the color corresponding to the pertinent life task category. Also, the experiencing person can write notes to himself (or others can write notes to her) on white paper, using the category-appropriate pen or marker 52 color. The experiencing person, upon later encountering the note, immediately has the added benefit of the color cue to indicate general nature of the note's subject matter.

In many instances, it may be desirable to mark temporarily a document or other item with a color tag according to the inventive system. In such cases, the colored self-adhesive note papers 50 may be used to tag or flag temporarily certain items or papers. For instance, the experiencing person during the course of the day may receive custody of an important document for which he must provide the proper disposition. But permanently marking the document with colored ink from a marking instrument 52 (such as an ink marker) or an adhesive sticker 54 may be inappropriate. By way of illustration, the experiencing person may purchase a new hardback book as a birthday gift for a friend; it would be inappropriate to write in the book or place a semi-permanent adhesive sticker 54 on it. Yet the experiencing person may have the need to categorize and tag the book, so that hours, days, or perhaps weeks later, he will be cued to the purpose of the book. According to the method of the invention, therefore, upon purchasing the book the experiencing person may temporarily place a pink note paper 50 from the pink packet 48 upon the book (pink indicating the life task category of “friends/sentimental”), with the friend's name written on the pink note paper 50 in dark ink.

Every few days, perhaps once a week, the users of the invention (experiencing person and his buddy) may need to set aside a quiet period of time, in a comfortable location, to sort together through the experiencing person's personal belongings, daily documents, wallet or purse, etc., and use the tools of the kit 10, including the color-coded system packets 41, 42, 44, 45, 46, 48, and 49, to classify, flag, and organize the objects and appointments of the experiencing person's life.

Preferably, the experiencing person does not initially immediately begin using the memory machine 26. Rather, the use of the more basic components of the kit 10, such as the daily planner book 20, color coding packets system 40, and the orange cord 34 are mastered and integrated in daily activity, and only then the memory machine 26 is introduced into the method. The use of the voice organizer 26 may begin months after commencement of the practicing of the invention, and the voice organizer may be programmed, at least initially, by the buddy rather than the experiencing person. Some users may never need to employ the memory machine 26; use of such a voice organizer is a preferable, but optional, step of the process.

The memory machine 26 is deployed as a complement to the daily planner book 22. For example, at the conclusion of one day, the information from the next day's pages in the planner book 22 is read into the voice-recognizing memory machine 26, and appropriate alarm functions set. The user may coordinate using the colors and life task categories. For example, at the close of the day the user can record into the machine 26, for the next day, that “two-thirty p.m. I have a blue life task, leave home to take Jimmy to swimming lessons.” Next, a message is recorded, “four p.m., leave to meet Don at bank, this is a green life task.” Then, at that those times the following day, the memory machine 26 sounds or flash an alarm, and plays back, in the user's own voice, the audio message reminder. The memory machine 26 thus serves as a back up to the daily planner book 22. As tasks are accomplished, they are erased from the memory machine 26. Important and emergency names and telephone numbers, as well as other re-useable information (including inspirational thoughts) also can be stored digitally in the memory machine 26.

All the foregoing is accomplished with the intimate assistance and ongoing support from the buddy, who uses similar tools, as needed, to assist the experiencing person in recalling and executing daily tasks.

A kit can be customized to address the problems an ever-increasing segment of our population—the senior, aging population. In addition, those in this aging population who are suffering from Alzheimer's disease and similar dementia, such as short term memory loss, inability to organize (sequencing), and attention deficits. The kit 10 re-introduces independence, greatly enhancing the quality of the patient's life.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents.

1. A kit for assisting a person afflicted with a brain function deficit to manage and cope with the tasks of daily life, said kit comprising:
a daily planner book, said book having pages therein demarking days of the week, upon which tasks and appointments may be written;
a color coding system comprising a collection of colored adhesive stickers, said collection comprising at least two groups of stickers, each group comprising a plurality of stickers of a selected color corresponding to one of a plurality of designated categories of life tasks, and each sticker adhesively attachable to a page of said planner book;
wherein said category of life tasks is a category selected from the group consisting of high priority tasks, ongoing tasks, financial tasks, personal health, hygiene and appearance tasks, and family tasks.

2. A kit according to claim 1 wherein a first one of said groups of stickers comprises a first plurality of stickers colored orange, corresponding to a category of high-priority life tasks.

3. A kit according to claim 2 further comprising at least six groups of said stickers, each said group comprising a plurality of stickers of a color distinct from the color of said stickers in any other of said six groups.

4. A kit according to claim 2 further comprising a flexible cord having a color substantially identical to the color of said first plurality of stickers.

5. A kit according to claim 1 further comprising at least two marking instruments, each instrument comprising means for marking in a selected color corresponding to one of said plurality of designated categories of life tasks.

6. A kit according to claim 4 further comprising at least two pads of removably adhesive note papers, each pad comprising a plurality of note papers of a selected color corresponding to one of said a plurality of designated categories of life tasks.

7. A kit according to claim 1 further comprising a voice organizer in which selected ones of said tasks and appointments recorded in said planner book may be audibly recorded for timed playback.

8. A kit according to claim 1 further comprising:
a personal workbook for use by a person having a brain function deficit; and
a buddy book for use by a person assisting the person having a brain function deficit.

9. A method for organizing and planning the life tasks of a person with a functional brain deficit, comprising the steps of:
selecting a plurality of life tasks needing organization;
assigning a different color to each of the life tasks, each color thereby corresponding to a task;
assembling a collection of colored adhesive stickers wherein the collection has at least two groups of stickers, each group comprising a plurality of stickers of a selected color corresponding to one of the plurality of designated selected categories of life tasks;
writing a particular life task annotation on the page of a planner book;
selecting an adhesive sticker of a color corresponding to the particular life task; and
affixing at least one colored sticker to the page adjacent to the annotation.

10. The method of claim 9 comprising the further steps of:
assembling a collection of colored self-adhesive note papers wherein the collection has at least two groups of note papers, each group comprising a plurality of note papers of a selected color corresponding to one of the plurality of selected categories of life tasks;
selecting a note paper of a color corresponding to a particular life task; and
temporarily attaching a note paper to an object associated with the life task.

11. The method of claim 9 comprising the further steps of:
assembling a collection of at least two colored writing instruments wherein each instrument marks in a selected color corresponding to one of the plurality of selected categories of life tasks;
selecting an instrument of a color corresponding to a particular life task; and
marking with the selected instrument the page adjacent to the annotation.

12. The method of claim 11 further comprising the step of marking with the selected instrument an object associated with the life task.

13. The method of claim 9 wherein the steps of claim 9 are performed by the person with a functional brain deficit with the assistance of a second person.

14. The method of claim 9 comprising the further step of viewing at least one of a series of audiovisual presentations of information regarding functional brain deficits.

15. The method of claim 14 wherein the step of viewing is performed by the person with a functional brain deficit and by a person selected to assist the person.

16. The method of claim 9 comprising the further steps of:
audio recording a reminder message regarding the particular life task in a digital voice organizer apparatus; and
replaying the reminder message to the person with a functional brain deficit.

17. A kit for helping a person with a brain function deficit comprising:
a color-coding system, said system comprising a plurality of color-coding packets wherein each said packet comprises a plurality of like-colored elements, wherein said like-colored elements comprise a distinct color which is substantially different than the distinctive color of elements of each of said other color-coding packets, and wherein each of said distinctive colors corresponds to an associated task selected from the group consisting of action, response, recognition, function, purpose, and need.

18. The kit of claim 1 further comprising audio visual instruction describing how to use said kit.

19. The kit of claim 1 further comprising instruction regarding one or more elements selected from the list consisting of identification of changes, placement of needed supports, selection of appropriate tools, progress charting, and combinations thereof.

20. The kit of claim 1 further comprising instruction regarding one or more elements selected from the list consisting of transition to a subsequent assistant, sharing of responsibilities with other assistants, self guidance, and combinations thereof.

21. The kit of claim 1 further comprising a voice organizer.

22. The kit of claim 1 further comprising a planner book.

23. The kit of claim 1 further comprising a flexible marking cord.

24. A method for helping a person with a brain function deficit comprising the steps of:
establishing a color-coding system, wherein each color of the system is related to one or more elements selected from the group consisting of a group of people, an ongoing project, tasks; and personal matters;
providing a plurality of color-coded items, wherein the items comprise a color in accordance with the established color-coding system; and
providing instruction regarding use of the color-coded system.

25. The method of claim 24 wherein the step of providing a plurality of items comprises providing a plurality of colored adhesive indicators.

26. The method of claim 25 further comprising the step of disposing the adhesive indicators on selected surfaces according to their color.

27. The method of claim 24 wherein the step of providing a plurality of items comprises providing a plurality of colored writing instruments.

28. The method of claim 24 wherein the step of providing a plurality of items comprises providing a plurality of colored folders.

29. The method of claim 24 wherein the step of providing a plurality of items comprises providing a voice recorder.

30. The method of claim 24 wherein the step of providing instruction comprises providing a first set of instructions to a person with a brain function deficit.

31. The method of claim 30 wherein the step of providing instruction further comprises providing a second set of instructions to a person assisting the person with a brain function deficit.
